(19) United States
(12) Patent Application Publication
(10) Pub. No.: US 2026/0164452 A1
(43) Pub. Date: Jun. 11, 2026

(54) MAC CE HANDLING FOR MULTIPLE DISTRIBUTED UNITS

(71) Applicant: QUALCOMM Incorporated, San Diego, CA (US)

(72) Inventors: Chiranjib SAHA, Lakeside, CA (US); John Wallace NASIELSKI, San Diego, CA (US); Abhishek Saurabh SACHIDANAND SINHA, San Diego, CA (US); Andrei Dragos RADULESCU, La Jolla, CA (US)

(21) Appl. No.: 18/974,652

(22) Filed: Dec. 9, 2024

(51) Int. Cl. H04W 72/27; H04W 80/02; H04W 92/20

(52) U.S. Cl. CPC H04W 72/27; H04W 80/02; H04W 92/20

(57) ABSTRACT

Certain aspects of the present disclosure provide techniques for wireless communications. An example method includes receiving medium access control (MAC) signaling associated with a user equipment (UE) from the UE or another DU; and processing the MAC signaling, wherein processing the MAC signaling comprises: consuming a MAC control element (MAC-CE) derived from the MAC signaling, or sending a message comprising the MAC-CE from a first medium access control (MAC) layer of the first DU to a second MAC layer of a second DU, over a DU-to-DU interface.

### INTRODUCTION

### Field of the Disclosure

Aspects of the present disclosure relate to wireless communications, and more particularly, to techniques for standardized direct inter-distributed unit communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications at a first distributed unit (DU). The method includes receiving medium access control (MAC) signaling associated with a user equipment (UE) from the UE or another DU; and processing the MAC signaling, wherein processing the MAC signaling comprises: consuming a MAC control element (MAC-CE) derived from the MAC signaling, or sending a message comprising the MAC-CE from a first medium access control (MAC) layer of the first DU to a second MAC layer of a second DU, over a DU-to-DU interface.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example open radio access network (O-RAN) framework utilizing multiple O-RAN distributed units (O-DUs).

FIG. 6 depicts an example of a deployment of a proposed distributed unit (DU)-to-DU interface for interoperability between O-DUs in an O-RAN setting.

FIG. 7 depicts a signaling process flow for communications in a network between network entities, including UEs using the DU-to-DU interface.

FIG. 8 depicts a signaling process flow for communications in a network between DUs over a DU-to-DU interface in a centralized processing DU architecture.

FIG. 9 depicts a signaling process flow for communications in a network between DUs over a DU-to-DU interface in a distributed processing DU architecture.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for direct inter-distributed unit communications.

Carrier Aggregation (CA) is a technique used in wireless communications to boost data speeds and network capacity by combining multiple component carriers (CCs) into one larger, unified channel to allow larger data transfers at a time and produce faster speeds.

Each CC of the CCs that are combined in CA may be a unit of bandwidth in mobile communication networks such as 5G. A CC therefore represents a resource that is made up of an individual block of spectrum that can be used for communications or to transmit data. Therefore, CCs are blocks that a radio spectrum used for communication can be divided into. A user equipment (UE) may be configured with multiple CCs, including a primary CC (also referred to as a primary cell or PCC) on which data communications and control communications are performed, and one or more secondary CCs (also referred to as secondary cells or SCCs) on which data communications are performed.

A distributed unit (DU) may provide a CC of a CA configuration, or may manage scheduling of other DUs in connection with the CA configuration. A DU is responsible for allocating radio resources, scheduling transmissions and generally managing a CC or a set of CCs. For instance, the DU can use multiple CCs to achieve CA with a specific combined bandwidth. The DU in traditional RAN architectures is typically a proprietary component associated with a specific vendor that comes as part of a unified proprietary and vertically integrated system. An open distributed unit (O-DU) is a type of DU deployed in modern telecommunication systems that leverage Open Radio Access Network (O-RAN) and its distributed and open (non-proprietary) framework, or another non-proprietary framework. An O-DU is a DU that can function in the O-RAN setting. O-RAN is intended to be an open system that allows telecommunication providers to use components (including O-DUs) from any vendor in various combinations as long as those components adhere to open standards and interfaces specified by O-RAN. Thus, O-RAN may allow for greater flexibility and reduces telecommunication providers being locked in to a vendor.

The O-DU also acts as an interface between the open-radio unit (O-RU) and the open-central unit (O-CU). The O-DU allows communication between the O-RU and the O-CU and translating between their different protocols and formats. Each of the units, the O-CU, the O-DU, and the O-RU, may include one or more interfaces or be coupled to one or more interfaces configured to receive or transmit signals, data, or information (collectively, signals) via a wired or wireless transmission medium. Each of the units can be configured to communicate with one or more of the other units via the transmission medium. The O-RU may handle physical layer functions. The O-DU may handle some physical layer functions, as well as medium access control (MAC) functions, radio link control (RLC) functions, or the like. The O-CU may handle packet data convergence protocol (PDCP) functions, among other higher-layer functions. For example, the O-DU communicates with the O-CU for higher-layer functions, while the O-DU handles lower layer functions of the O-RAN with the O-RU. This separation between the functions of the O-DU and the O-CU allows for modular, customizable, and scalable network solutions.

CA may be used for uplink or downlink transmissions. “Uplink CA” (UL CA) refers to performing CA in an uplink direction, e.g., combining CC's for UE transmissions to a network. Meanwhile, “downlink CA” (DL CA) refers to the aggregation of CCs for transmissions traveling from the network to the UE. DL CA may be governed by the O-CU or an O-DU that provides a primary cell, where the O-CU or the O-DU can send instructions to various O-DUs that provide secondary cells or the primary cell. By contrast, UL CA relies on each individual O-DU to receive communications sent by the UE and processing the communications locally before sending them to the O-CU.

CA functionality may benefit from communication between O-DUs, such as to schedule communications, forward signaling or communications to one another, or combine the various CCs, e.g., the PCC and SCCs. This inter-O-DU communication is especially important in the context of UL CA where the O-DU is the first point in the system that receives UL transmissions from the UE from the O-RU. Unlike in DL CA that can be directed by the O-CU, the O-CU is not immediately involved in managing the uplink communication of the O-DUs in UL CA. Closed proprietary systems that rely on only one vendor's DUs may allow the DUs to communicate with each other to deliver CA with their proprietary communications system. However, difficulty may arise when considering UL CA for multiple O-DUs from multiple vendors, since these O-DUs may not readily communicate with each other under available frameworks in O-RAN. Furthermore, some forms of signaling, such as signaling between DUs via a common CU or via CU-to-CU signaling, may introduce untenable delay to operation of the DUs.

Aspects presented herein include a communications interface in a network, e.g., a DU-to-DU interface to enable CA (as well as other functions) to be performed with multiple O-DUs. A communications interface can include a connection between different units of the network, such as user equipment, base stations or between their respective components. A communications interface may define the type of component or device used for or able to utilize the interface, signaling protocols, messaging formats, and any specific procedures involved to perform the communication. The disclosed communications interface leverages O-RAN's open architecture to enable the addition, deployment, and use of multiple O-DUs from multiple vendors in a telecommunications network to deliver CA functionality. In some examples, the communications interface may provide a unified and/or standardized way for O-DUs to communicate with another. Specifically, the communications interface may provide for handling of MAC signaling in association with UL CA. In some aspects, the communications interface allows centralized processing of MAC signaling and DU-to-DU messages at a primary DU. In some aspects, the communications interface allows for distributed processing of MAC signaling and DU-to-DU messages at any DU that receives these messages. The DU-to-DU interface enables these aspects by enabling direct communication of messages such as MAC-CEs between DUs, e.g., O-DUs, via their respective MAC layers. For example, the DU-to-DU interface may connect a first DU to a second DU through a first MAC layer of the first DU and the second MAC layer of the second DU. This may be implementable even at DUs provided by different vendors.

The benefits of the aspects presented include improving the modularity of O-DUs by adding interoperability between O-DUs. Interoperability allows O-DUs to directly communicate with each other even when they do not share the same underlying operating system or run on the same servers, which makes it possible for telecommunications providers to quickly deploy O-DUs of any vendor type, for example in cases of malfunctions or network overload where CA functionality is sought. Modularity is also improved with interoperability as it brings about backward compatibility support since various O-DUs of different generations may work together using a common interface. The ability of O-DUs to be deployed more readily provides stability to a telecommunications system by making it easier to replace one O-DU with another or add new O-DUs.

The solution presented also reduces latency in the telecommunications system as a whole. This is because various tasks (as assigned by the network provider) such as forwarding of MAC signaling are able to bypass the O-CU, and may be performed directly between the O-DUs. The removal of the O-CU overhead increases the rate of transmission and speed of communications reducing overall latency.

Because CA is no longer limited by the capabilities of existing O-DUs, the presented solutions increase the ability of networks to utilize CA in broader contexts by more easily adding additional O-DUs when needed. The increased deployment of CA provides faster data speeds, improves resource allocation efficiency, and lowers latency, amongst various other benefits derived from increased CA deployment.

One benefit is provided by centralized processing of the MAC signaling and the DU-to-DU messages at a primary DU. This reduces latency by simplifying the processing of such signals and messages by having all secondary O-DUs automatically forward all MAC signaling and messages to this primary DU, which then may perform many of the functions of a central processor without having to translate between or migrate through various layers and protocols, e.g., between the MAC and RLC layers as would occur when an O-CU communicates with an O-DU.

Another benefit is provided by the distributed processing of the MAC signaling and of the DU-to-DU messages. This enables the first O-DU that receives these signals to perform processing and immediately consume or forward remaining messages to other DUs. This allows all the DUs to possess the same functionality, which reduces complexity and allowing each DU to determine actions independently, removing single points of failure, which builds reliability and resilience in the system. Furthermore, the usage of distributed processing may reduce processing burden that would otherwise exist at a DU designated as a primary DU.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

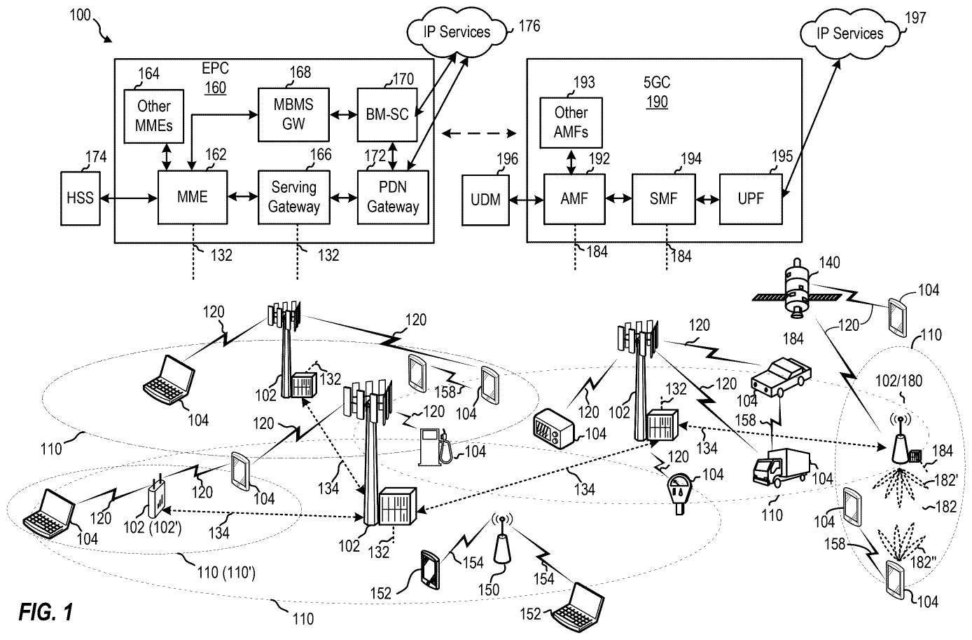

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

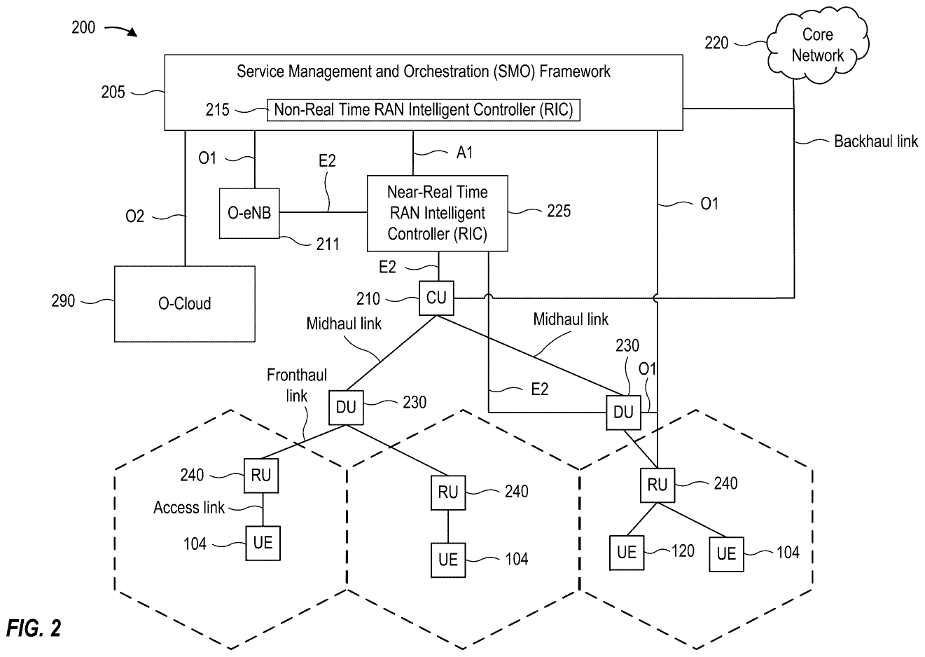

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1(FR 1 ) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205. The CUs 210 can include O-CUs which are CUs that function in an O-RAN setting. Similarly, the DUs 230 can include O-DUs, and the RUs 240 can include O-RUs that function within an O-RAN framework.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

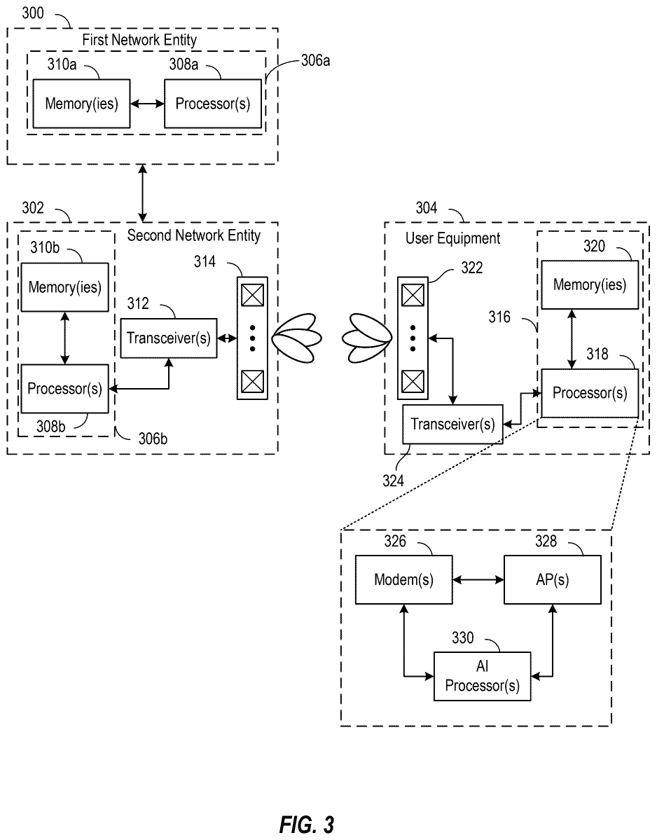

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

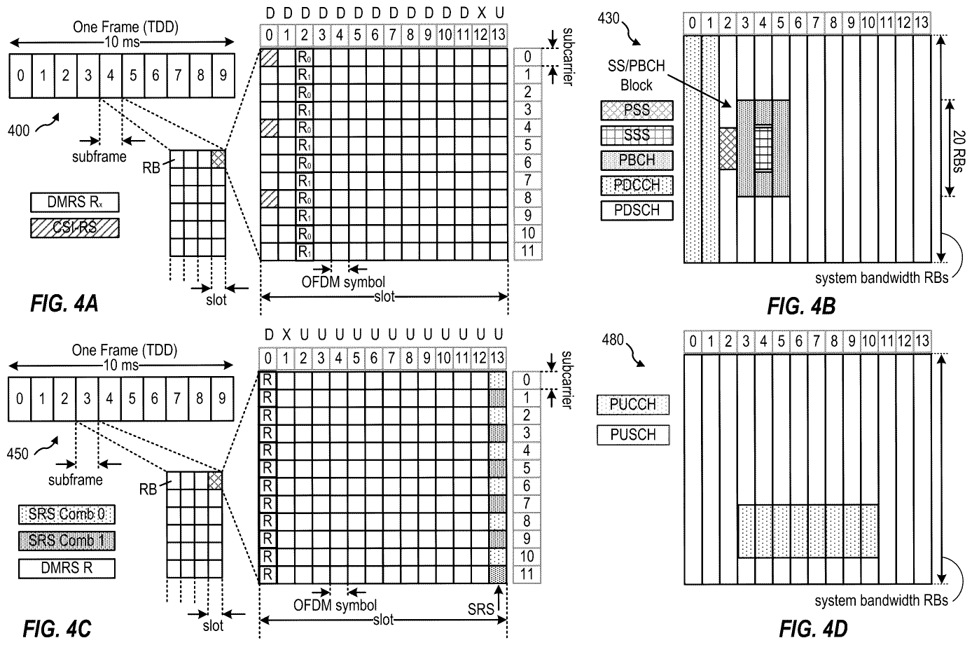

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Standardized Direct Inter-Distributed Unit Communications

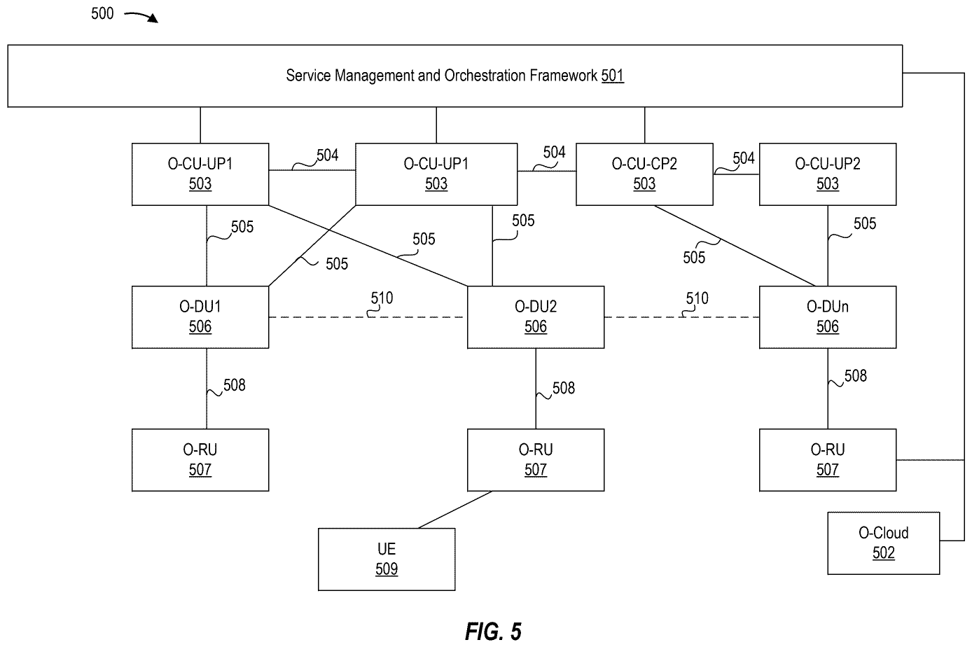

FIG. 5 depicts an example 500 O-RAN framework utilizing multiple O-DUs. The example 500 includes a service management and orchestration framework (SMO) 501, an O-Cloud 502. The SMO 501 orchestrates services across physical and virtual network assets and resources in the example 500. The SMO 501 may correspond to the SMO 205 of FIG. 2. For example, the SMO plays a role in the automation of network functions, service provisioning, monitoring, and optimization. The O-Cloud 502 is the platform that enables the disaggregated telecom network to run on cloud infrastructure, for example via virtualized modular components as well as physical components connected to the O-Cloud 502. The O-Cloud 502 may correspond to the O-Cloud 290 of FIG. 2.

The example 500 also includes one or more O-CUs 503. The O-CUs 503 may include an O-CU that manages user plane operations (illustrated as O-CU-UP) or those an O-CU that manages control plane operations (O-CU-CP). The O-CUs 503 may correspond to the CU 210 of FIG. 2. The O-CUs 503 can communicate to each other via interfaces 504 that may include an Xn (including Xn-C and XN-U) interface and/or an NG interface (including NG-C and NG-U).

The O-CUs 503 may communicate with and send instructions to O-DUs 506 via O-CU-to-O-DU interfaces 505 that may can include the F1 (including F1-U and F1-C) and E1 interfaces. The O-DUs 506 are connected to O-RAN radio units 507 (O-RUs) 507 via an open fronthaul 508. The O-RUs 507 are responsible for handling the physical layer (Layer 1) operations of the O-RAN. For example, an O-RU 507 may process signals, modulate and demodulate radio signals, and transmit signals over the air. The O-RUs 507 are typically deployed at the cell site or near antennas that connect to a UE 509 (e.g., UE 104, UE 304). The O-DUs 506 may correspond to the DU 230 of FIG. 2. The O-RUs 507 may correspond to the RU 240 of FIG. 2.

Aspects described herein introduce an O-DU-to-O-DU interface 510 represented by the dashed lines connecting O-DUs 506 directly to one another. This O-DU-to-O-DU interface 510 allows direct communications and interoperability between the O-DUs 506, such as in an O-RAN setting. The proposed O-DU-to-O-DU interface 510 presents an improvement over a traditional approach, where signals and messages have to be processed by an O-CU 503. In traditional approaches, O-DUs 506 having the same O-CU 503 would use the shared O-CU 503 to coordinate activities between them. If the O-DUs 506 are associated with different O-CUs 503, then those O-CUs 503 would communicate to each other via interfaces 504 to coordinate the activities of the O-DUs 506. The aspects presented herein allow the O-DUs 506 to perform this processing in connection with communications via the O-DU-to-O-DU interface 510. This may be done in a central or distributed basis by one or more of the O-DUs 506.

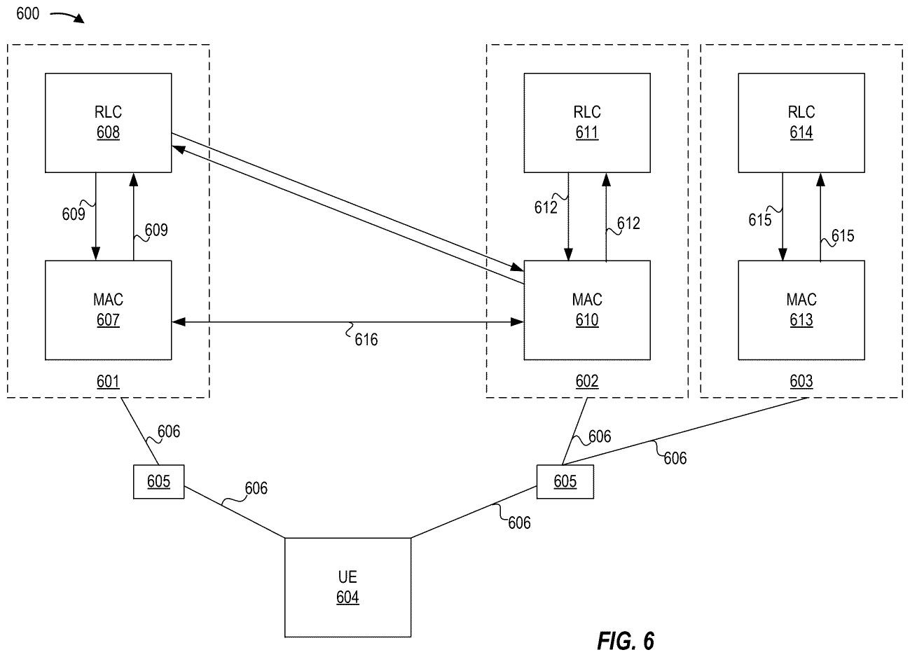

FIG. 6 depicts an example 600 of a deployment of a proposed DU-to-DU interface for interoperability between O-DUs in an O-RAN setting.

The example 600 includes any number of DUs deployed in an O-RAN setting. For example, the DUs of the example 600 may include a first O-DU 601, a second O-DU 602, and a third O-DU 603. The O-DUs 601-603 may each correspond to the DU 230 of FIG. 2 or O-DUs 506 of FIG. 5.

The example 600 also includes any number of UEs, e.g., the UE 604. The UE 604 can correspond to the UE 104 of FIGS. 1-2, the UE 304 of FIG. 3, and/or the UE 509 of FIG. 5. The UE 604 communicates with the O-DUs 601-603 via O-RUs 605 using an open fronthaul 606. The O-RUs 605 can correspond to the RU 240 of FIG. 2 or the O-RU 507 of FIG. 5. The open fronthaul 606 may correspond to the open fronthaul 508 of FIG. 6.

Each of the O-DUs 601-603 may comprise an RLC layer and a MAC layer. A MAC layer can be responsible for various transmission resources and management of these resources. For example the MAC layer can schedule transmissions and allocate resources between various devices. The RLC layer ensures the reliability of data transmissions. For example the RLC layer may handle errors and may maintain a stable link between various virtualized and physical devices.

The first O-DU 601 includes MAC layer 607 and RLC layer 608 which communicate with each other via transmissions 609. The second O-DU 602 includes MAC layer 610 and RLC layer 611 which communicate with each other via transmissions 612. The third O-DU 603 includes MAC layer 613 and RLC layer 614 which communicate with each other via transmissions 615.

The example 600 also includes a DU-to-DU interface 616 that connects the O-DUs 601-603 to each other. For example, the DU-to-DU interface 616 may provide communication between MAC layers 607, 610, and 613. For example, the DU-to-DU interface 616 connects the MAC layer 607 of the first O-DU 601 to the MAC layer 610 of the second O-DU 602. The first O-DU 601 may send or receive messages to or from the second O-DU 602 via the DU-to-DU interface 616. The DU-to-DU interface 616 may correspond to the DU-to-DU interface 510 of FIG. 5.

In some aspects, the DU-to-DU interface may comprise a different DU interface 617 that connects an RLC layer of one O-DU to a MAC layer of another O-DU. For example, the RLC layer 608 of the first O-DU 601 may send or receive data to or from the MAC layer 610 of the second O-DU 602 via the DU-to-DU interface 617.

In some aspects, one of the O-DUs 601-603 is elected as a primary DU to process MAC signaling received from the UE 604 or from other O-DUs 601-603, and distribute the MAC signaling to an intended or most appropriate target DU of the DUs 601-603. Thus, the primary DU may centrally process the MAC signaling. In some aspects, the O-DUs 601-603 may be part of a distributed DU processing architecture process where each of the O-DUs 601-603 process or distribute any MAC signal or message containing a MAC-CE received from a UE or another O-DU 601-603. In the distributed DU processing architecture, a given O-DU 601-603 may process received MAC signaling even if the received MAC signaling is destined to another O-DU 601-603.

### Example Signaling of Standardized Direct Inter-Distributed Unit Communications

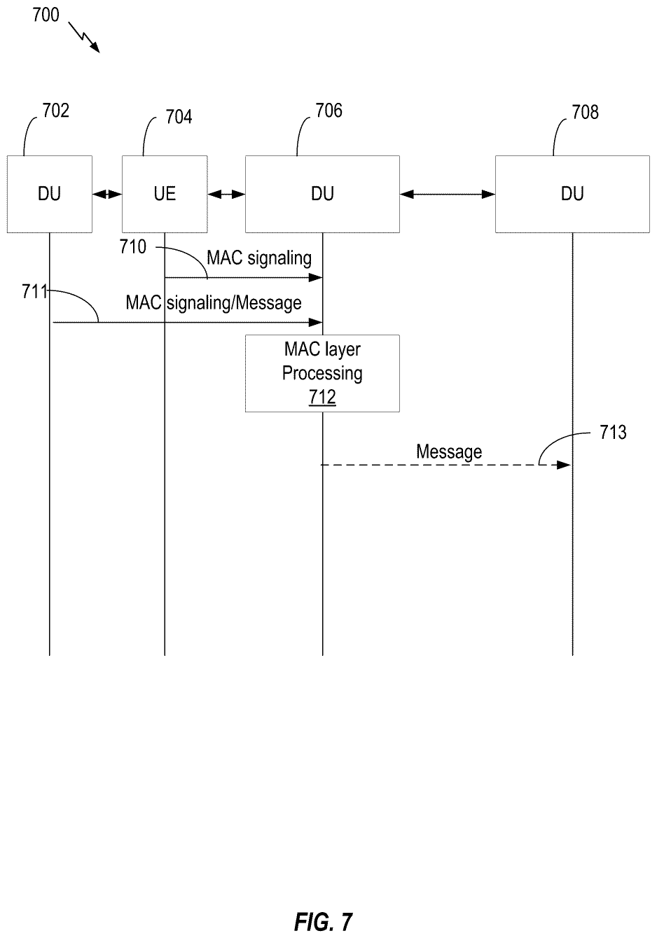

FIG. 7 depicts a process flow 700 for communications in a network between DUs, e.g., O-DUs, over a communications interface such as a DU-to-DU interface.

FIG. 7 includes a DU 702, a UE 704, a first DU 706, and a second DU 708. Each of the DU 702, the first DU 706, and the second DU 708 may provide a respective CC associated with transmissions of the UE 704. In some aspects, any of the DU 702, the first DU 706, and the second DU 708 may be an example of the BS 102 depicted and described with respect to FIG. 1, the first network entity 300 or the second network entity 302 depicted and described with respect to FIG. 3, a disaggregated base station (or an element thereof, such as a DU) depicted and described with respect to FIG. 2, an O-DU 506 depicted and described with respect to FIG. 5, or O-DUs 601-603 depicted and described with respect to FIG. 6. Similarly, the UE 704 may correspond to the UE 104 depicted and described with respect to FIG. 1, the UE 304 depicted and described with respect to FIG. 3, the UE 509 of FIG. 5, or the UE 604 depicted and described in FIG. 6. Note that any operations or signaling illustrated with dashed lines may indicate that that operation or signaling is an optional or alternative example.

In some aspects, the UE 704 sends at 710 a MAC signaling (signaling to be received or decoded at the MAC layer of a recipient DU). The first DU 706 receives the MAC signaling for example via an O-RU, such as the O-RU 605 described in FIG. 6. The MAC signaling can include a UE identifier (UE ID) of the UE 704. In some aspects, the UE ID can include or be indicated using a Cell Radio Network Temporary Identifier (C-RNTI) of the UE 704. The MAC signaling may include or be a MAC control element (MAC-CE) or multiple MAC-CEs.

In some aspects, the first DU 706 receives at 710 the MAC signaling which includes the MAC-CE from the UE 704 over at least one of an uplink shared channel (UL-SCH), a physical uplink control channel (PUCCH), or a physical uplink shared channel (PUSCH).

In some aspects, the DU 702 at 711 sends and the first DU 706 receives the MAC signaling. For example, the DU 702 may forward the MAC signaling from the UE 704, or may process a MAC-CE from the UE 704 and generate the MAC signaling based on processing the MAC-CE. The MAC signaling may be sent and received via a DU-to-DU interface e.g., the DU-to-DU interface 616 of FIG. 6, as a message at a MAC layer of the first DU 706. The MAC signaling can include a UE ID of the UE 704. In some aspects, the UE ID can include or be indicated by a C-RNTI of the UE 704. The MAC signaling may also include a MAC-CE or multiple MAC-CEs. Thus, as described herein, MAC signaling received by the first DU 706 may originate from the UE 704 (e.g., directly) or from a DU 702 (e.g., based on the DU 702 receiving the MAC signaling and forwarding the MAC signaling to the second DU 708).

In some aspects, at 712, the first DU 706 processes the received MAC signaling. Processing the MAC signaling may include decoding content of the MAC signaling or forwarding the MAC signaling to the RLC layer of the first DU 706 e.g., via logical channels. In some aspects, the processing 712 includes consuming the MAC signaling received at 710. Consuming the MAC signaling may include accessing or analyzing information contained within the MAC signaling. For example, consuming the MAC signaling may include parsing a MAC-CE of the MAC signaling, implementing an indication of the MAC-CE (e.g., a power headroom value, a beam indication, etc.), or the like. In some cases, consuming a message also includes sending an acknowledgement or clearing received data as a completed task from memory or similar to ensure that the first DU 706 is ready for new MAC signals or messages. For example, the first DU 706 may determine the content of the MAC signaling and any actions to perform, such as storing the data, allocating a resource, or scheduling a transmission and the like based on the MAC CE.

In some aspects, at 713 the first DU 706 sends a message from a MAC layer of the first DU 706 to a MAC layer of the second DU 708, which receives the message via a DU-to-DU interface. The sending at 713 may occur as part of the processing at 712. The DU-to-DU interface may be a user-plane interface directly connecting the MAC layers of each DU to the MAC layer of the other DU, e.g., that corresponds to the DU-to-DU interface 510 of FIG. 5 or the DU-to-DU interface 616 of FIG. 6. The message can include a UE ID, such as a UE ID of the UE 704. In some aspects, the UE ID can include a C-RNTI, such as a C-RNTI associated with the UE 704.

In some aspects, the MAC signaling includes a multiple entry PHR in the MAC-CE. A PHR indicates to the first DU 706 how much power is available for transmissions of the UE 704 above a current transmission power of the UE 704. The multiple entry PHR indicates the same information regarding multiple devices, frequencies, CCs, or other resources.

In some aspects, the first DU 706 that receives the multiple entry PHR consumes the multiple entry PHR that is associated with the first DU 706, e.g., during the processing at 712. After consuming the multiple entry PHR MAC-CE, the first DU 706 then creates new MAC-CEs during the processing at 712. The new MAC-CEs may be created based on a CC to DU mapping. A CC to DU mapping may indicate a DU associated with a CC. For example, a CC to DU mapping may map CCs to DUs that provide the CCs. The first DU 706 then sends the new MAC-CEs as a message over the DU-to-DU interface to one or more intended DUs (e.g., as indicated by the CC to DU mapping), such as the second DU 708, as shown for example at 713.

Note that the process flow illustrated in FIG. 7 is an example of communications using a DU-to-DU interface, and aspects of the present disclosure may be applied to NEs. Note that the process flow illustrated in FIG. 7 is described herein to facilitate an understanding of a standardized direct inter-distributed unit communication interface, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

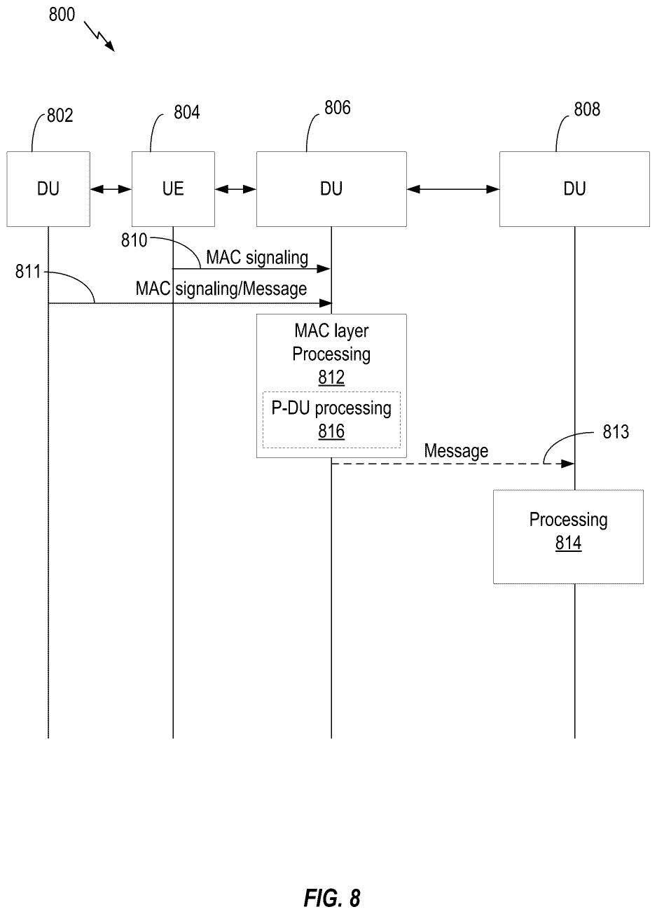

FIG. 8 depicts a process flow 800 for communications in a network between DUs over a communications interface such as a DU-to-DU interface in a centralized processing DU architecture. FIG. 8 includes a DU 802, a UE 804, a first DU 806 and a second DU 808.

The process flow 800 involves a centralized processing DU architecture where one DU from the DUs is assigned or elected as a primary DU (P-DU) while the other DUs are secondary DUs (S-DUs). The primary DU receives messages and MAC signaling and processes them (e.g., centrally). The primary DU then sends the MAC signaling, or information derived from the MAC signaling (e.g., a MAC-CE) to one or more of the other DUs directly via a DU-to-DU interface, e.g., the DU-to-DU interface 616 of FIG. 6.

In some aspects, any of the DU 802, the first DU 806, or the second DU 808 may be examples of the BS 102 depicted and described with respect to FIG. 1, the first network entity 300 or the second network entity 302 depicted and described with respect to FIG. 3, a disaggregated base station (or an element thereof, such as a DU) depicted and described with respect to FIG. 2, an O-DU 506 depicted and described with respect to FIG. 5, or O-DUs 601-603 depicted and described with respect to FIG. 6. The UE 804 may correspond to the UE 104 depicted and described with respect to FIG. 1, the UE 304 depicted and described with respect to FIG. 3, the UE 509 of FIG. 5, or the UE 604 depicted and described in FIG. 6. Note that any operations or signaling illustrated with dashed lines may indicate that that operation or signaling is an optional or alternative example.

An SMO such as the SMO 501 of FIG. 5 may elect or select the first DU 806 as the P-DU, while the other DUs in FIG. 8 are S-DUs. In some aspects, the first DU 806 is elected or selected as the P-DU because it has established a connection, e.g., a control signal connection with a UE, e.g., the UE 804. The P-DU may also be elected or selected by being configured to provide a primary cell of a UE, e.g., the UE 804. For example, a DU that provides a primary cell of the UE 804 may function as a P-DU.

In some aspects, the UE 804 sends at 810 a MAC signaling. The first DU 806 receives the MAC signaling for example via an O-RU, such as the O-RU 605 described in FIG. 6. The MAC signaling can include a UE identifier (UE ID) of the UE 804. In some aspects, the UE ID can include or be indicated by a C-RNTI of the UE 804. The MAC signaling may also include a MAC-CE or multiple MAC-CEs.

In some aspects, when the sending at 810 is performed by the UE 804, the first DU 806 receives at 810 the MAC signaling from the UE 804 over at least one of a UL-SCH, a PUCCH, or a PUSCH.

In some aspects, at 811, the DU 802 sends and the first DU 806 receives the MAC signaling. For example, the first DU 806 may forward the MAC signaling, or may at 812 process the MAC-CE and generate MAC signaling or a message based on processing the MAC-CE. The MAC signaling may be sent and received via a DU-to-DU interface e.g., the DU-to-DU interface 616 of FIG. 6, as a message at a MAC layer of the first DU 806. The MAC signaling can include a UE ID of the UE 804. In some aspects, the UE ID can include or be indicated by a C-RNTI of the UE 804. In some aspects, the MAC signaling is received at a MAC layer of the first DU 806. The MAC signaling may also include a MAC-CE or multiple MAC-CEs. Thus, as described herein, MAC signaling received by the first DU 806 may originate from the UE 804 (e.g., directly) or from a DU 802 (e.g., based on the DU 802 receiving the MAC signaling and forwarding the MAC signaling to the second DU 808).

In some aspects, at 812, the first DU 806 processes the received MAC signaling. Processing the MAC signaling may include decoding contents of the MAC signaling or the MAC signaling to the RLC layer of the first DU 806 e.g., via logical channels. In some aspects, the processing at 812 includes consuming the MAC signaling received at 810. Consuming the MAC signaling may include accessing or analyzing information contained within the MAC signaling that is received at 810. For example, consuming the MAC signaling may include parsing a MAC-CE of the MAC signaling, implementing an indication of the MAC-CE (e.g., a power headroom value, a beam indication, etc.), or the like. In some cases, consuming a message also includes sending an acknowledgement or clearing received data as a completed task from memory or similar to ensure that the first DU 806 is ready for new MAC signals or messages. For example, the first DU 806 may determine the content of the MAC signaling and any actions to perform, such as storing the data, allocating a resource, or scheduling a transmission and the like based on the MAC CE and eliminating the data after.

In some aspects, at 813 the first DU 806 sends a message from a MAC layer of the first DU 806 to a MAC layer of the second DU 808, which receives the message via a DU-to-DU interface. The sending at 813 may occur as part of the processing at 812. The DU-to-DU interface may be a user-plane interface directly connecting the MAC layers of each DU to the MAC layer of the other DU, e.g., that corresponds to the DU-to-DU interface 510 of FIG. 5, or the DU-to-DU interface 616 of FIG. 6. The message can include a UE ID, e.g., of the UE 804. In some aspects, the UE ID can include a C-RNTI of the UE 804. The first DU 806 processes the MAC signaling at 812 (e.g., based on the first DU 806 being the P-DU) and sends the MAC signaling or information derived from the MAC signaling at 813 to the second DU 808 as a message over the DU-to-DU interface described above. The second DU 808 is the intended S-DU based on the MAC-CE in the MAC signaling received at 810. For example, the MAC signaling or the MAC-CE may indicate a cell or CC, and the cell or CC may be mapped to the second DU 808 according to a CC to DU mapping. At 814 the second DU 808 then processes and consumes the MAC-CE from the message sent to it at 813.

Optionally, when the first DU 806 is the P-DU, the processing at 812 may comprise P-DU processing at 816 which includes parsing the MAC signaling received at 810 by the MAC layer of the first DU 806. The parsing may include deriving a MAC-CE from the signaling. The first DU 806 may then determine an association between the MAC-CE to the intended DU, e.g., the second DU 808. For example, the first DU 806 may determine the association using a CC to DU mapping. At 812, the MAC-CE is sent in the form of a message to the second DU 808 over the DU-to-DU interface as described above.

In some aspects, the DU 802 is an S-DU. If the DU 802 is an S-DU, the DU 802 may send at 811 any MAC signaling that the DU 802 receives from a UE 804 to the first DU 806 (the P-DU) to be processed. For example, a DU may receive a MAC-CE and may forward the MAC-CE transparently to the P-DU. The first DU 806 receives the MAC signaling at 811 as a message over the DU-to-DU interface as described above.

In some aspects, during UL CA a UE 804 sends the MAC signaling at 810 to the first DU 806, where the MAC signaling includes a multiple entry PHR in the MAC-CE. In some aspects, the first DU 806 receives the MAC signaling comprising the multiple entry PHR in the MAC-CE at 810 or 811, and may send the MAC signaling to the P-DU for processing. If the first DU 806 is the P-DU, it creates new MAC-CEs during the P-DU processing at 816. The new MAC-CEs may be created based on a CC to DU mapping. For example, the new MAC-CEs may include or be associated with information that indicates an intended S-DU as a recipient of the new MAC-CEs. Additionally, or alternatively, the new MAC-CEs may include single-entry MAC-CEs directed to each recipient of an entry of the multiple entry PHR. The first DU 806 then sends the new MAC-CEs as a message over the DU-to-DU interface to the intended S-DU, e.g., the second DU 808, e.g., at 813.

In some aspects, the first DU 806 that receives the multiple entry PHR consumes the multiple entry PHR that is associated with the first DU 806, e.g., during the processing at 812. After consuming the multiple entry PHR MAC-CE, the first DU 806 then creates new MAC-CEs during the P-DU processing at 816. The new MAC-CEs may be created based on a CC to DU mapping. The first DU 806 then sends the new MAC-CEs as a message over the DU-to-DU interface to a set of intended S-DUs, e.g., the second DU 808, as illustrated at 813.

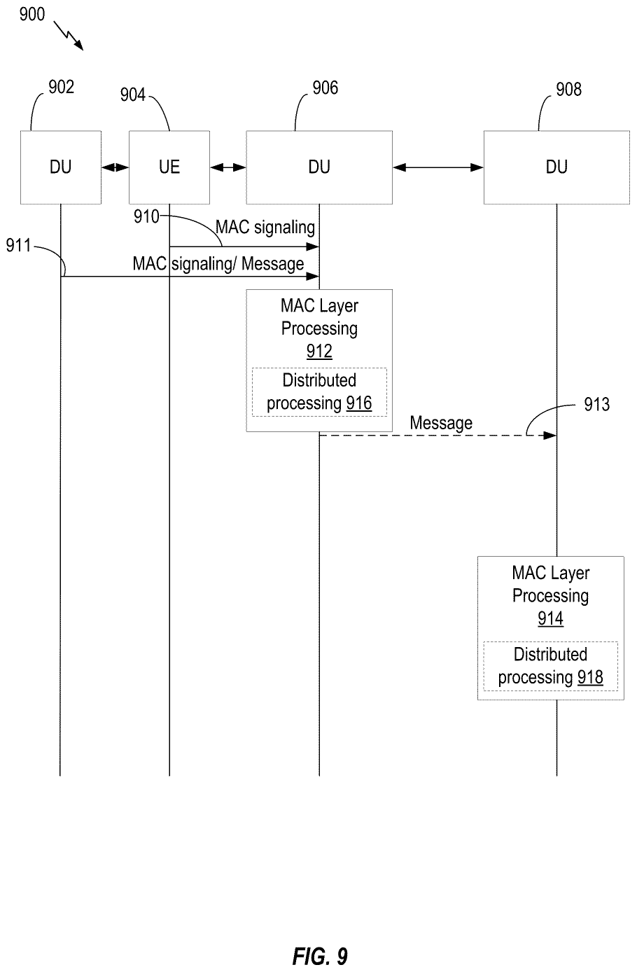

FIG. 9 depicts a process flow 900 for communications in a network between DUs over a communications interface such as a DU-to-DU interface.

FIG. 9 includes a DU 902, a UE 904, a first DU 906 and a second DU 908 in a distributed processing DU architecture.

In a distributed processing DU architecture, each DU processes and consumes MAC-CEs received from any source, e.g., received from any UE or from another DU over a DU-to-DU interface, e.g., the DU-to-DU interface 616 of FIG. 6.

In some aspects, any of the DU 902, the first DU 906, or the second DU 908 may be an example of the BS 102 depicted and described with respect to FIG. 1, the first network entity 300 or the second network entity 302 depicted and described with respect to FIG. 3, a disaggregated base station (or an element thereof, such as a DU) depicted and described with respect to FIG. 2, an O-DU 506 depicted and described with respect to FIG. 5, or O-DUs 601-603 depicted and described with respect to FIG. 6. The UE 904 may correspond to the UE 104 depicted and described with respect to FIG. 1, the UE 304 depicted and described with respect to FIG. 3, the UE 509 of FIG. 5, or the UE 604 depicted and described in FIG. 6. Note that any operations or signaling illustrated with dashed lines may indicate that that operation or signaling is an optional or alternative example.

In some aspects, the UE 904 sends at 910 a MAC signaling (signaling to be received or decoded at the MAC layer of recipient DU). The first DU 906 receives MAC signaling for example via an O-RU, such as the O-RU 605 described in FIG. 6. The MAC signaling can include a UE ID of the UE 904. In some aspects, the UE ID can include or be indicated by a C-RNTI of the UE 904. The MAC signaling may also include a MAC-CE or multiple MAC-CEs.

In some aspects, when the sending at 910 is performed by the UE 904, the first DU 906 receives at 910 the MAC signaling which includes the MAC-CE from the UE 904 over at least one of a UL-SCH, a PUCCH, or a PUSCH.

In some aspects, at 911, the DU 902 sends and the first DU 906 receives MAC signaling. For example, the DU 902 may forward the MAC signaling from the UE 904, or may process a MAC-CE from the UE 904 and generate the MAC signaling based on processing the MAC-CE. The MAC signaling may be sent and received via a DU-to-DU interface, e.g., the DU-to-DU interface 616 of FIG. 6, as a message at a MAC layer of the first DU 906. The MAC signaling can include a UE ID of the UE 904. In some aspects, the UE ID can include or be indicated by a C-RNTI of the UE 904. The MAC signaling may also include a MAC-CE or multiple MAC-CEs. In some aspects, the MAC signaling is received at a MAC layer of the first DU 906. Thus, as described herein, MAC signaling received by the DU 906 may originate from the UE 904 (e.g., directly) or from a DU 902 (e.g., based on the DU 902 receiving the MAC signaling and forwarding the MAC signaling to the second DU 908).

At 912, the first DU 906 processes the received MAC signaling. Processing the MAC signaling may include decoding content of the MAC signaling or forwarding the MAC signaling to the RLC layer of the first DU 906 e.g., via logical channels. In some aspects, the processing at 912 includes consuming the MAC signaling received at 910. Consuming the MAC signaling may include accessing or analyzing information contained within the MAC signaling that is received at 910. For example, consuming the MAC signaling may include parsing a MAC-CE of the MAC signaling, implementing an indication of the MAC-CE (e.g., a power headroom value, a beam indication, etc), or the like. In some cases, consuming a message also includes sending an acknowledgement or clearing received data as a completed task from memory or similar to ensure that the first DU 906 is ready for new MAC signals or messages. For example, the first DU 906 may determine the content of the MAC signaling and any actions to perform, such as storing the data, allocating a resource, or scheduling a transmission and the like based on the MAC CE and eliminating the data after.

In some aspects, at 913 the first DU 906 sends a message from a MAC layer of the first DU 906 to a MAC layer of the second DU 908, which receives the message via a DU-to-DU interface. The sending at 913 may occur as part of the processing at 912. The DU-to-DU interface may be a user-plane interface directly connecting the MAC layers of each DU to the MAC layer of the other DU, e.g., that corresponds to the DU-to-DU interface 510 of FIG. 5, or the DU-to-DU interface 616 of FIG. 6. The message can include a UE ID, e.g., of the UE 904. In some aspects, the UE ID can include C-RNTI, e.g., of the UE 904.

In some aspects, in the distributed processing DU architecture described herein, the DUs 902, 906 and 908 consume any MAC-CE that is received, whether received from a UE (e.g., received by the first DU 906 at 910 from the UE 904) or received from another DU (e.g., received at 911 by the first DU 906 from the DU 902, or received by the second DU 908 at 913 from the first DU 906). In some aspects of a distributed DU architecture, when the first DU 906 receives a MAC signaling at 908 from the UE 904, for example over a UL-SCH, e.g., at 910, the first DU 906 uses the MAC signaling to determine during the processing at 912 a target DU for the MAC-CE received at 910. For example, the first DU 906 may at 912 process the MAC-CE received in the MAC signaling to determine the target DU that the MAC-CE should be sent to. If the target DU is the second DU 908, then the processing at 912 also includes sending at 913 the MAC-CE as part of a message over the DU-to-DU interface to the second DU 908.

In some aspects, the first DU 906 when part of a distributed processing DU architecture consumes the received MAC-CE from the MAC signaling received at 910 from the UE 904. This consuming could occur as part of the processing 912. For example, when the distributed processing DU architecture is deployed, and the first DU 906 receives a message at 910, and when it is the target DU, the first DU 906 immediately consumes the received MAC-CE at 912.

In some aspects, the processing at 912 may include optional distributed processing at 916 by the first DU 906. As part of the distributed processing at 916, the first DU 906 generates a new MAC-CE for the target DU, e.g., the second DU 908. When generating the new-MAC-CE, the first DU 906 may consume any MAC-CE intended for the second DU 908. The new MAC-CE may be packaged as part of a message sent at 913 to the second DU 908.

The first DU 906 then may send at 913 the new MAC-CE to the determined target DU, e.g., the second DU 908, as part of a message sent via the DU-to-DU interface from the MAC layer of the first DU 906 to the MAC layer of the second DU 908. In some aspects, the second DU 908 (in a distributed processing DU architecture) consumes any MAC CE received from another DU, e.g., from the first DU 906 or from any UE, e.g., the UE 904.

In some aspects, the second DU 908 also performs distributed processing at 918 which may correspond to the distributed processing 916 described above. In some aspects, the distributed processing at 916 occurs separately from the processing at 912.

### Example Operations

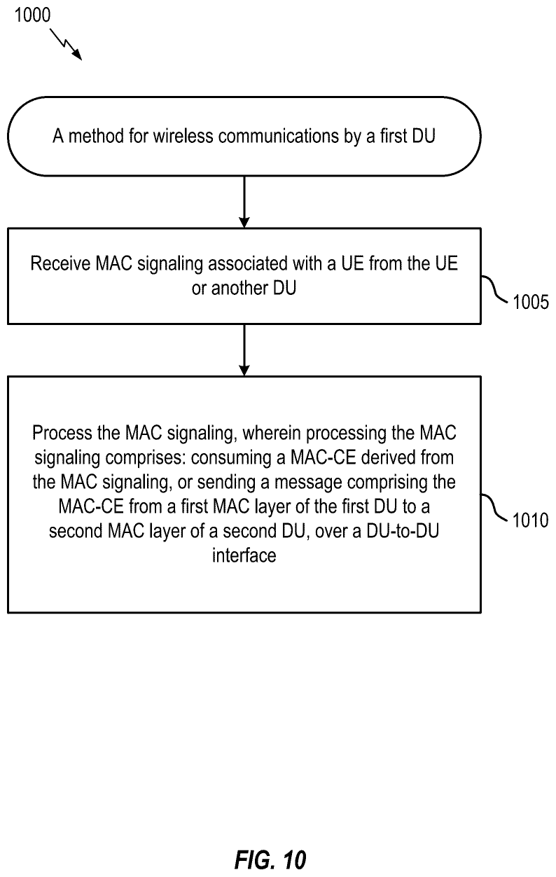

FIG. 10 shows a method 1000 for wireless communications by an apparatus, such as BS 102 of FIG. 1, a first network entity 300 or second network entity 302 of FIG. 3, or a disaggregated base station as discussed with respect to FIG. 2.

Method 1000 begins at block 1005 with receiving MAC signaling associated with a UE from the UE or another DU. For example, block 1005 may correspond to 710 and 711 of FIGS. 7, 810 and 811 of FIG. 8, or 910 and 911 of FIG. 9.

Method 1000 then proceeds to block 1010 with processing the MAC signaling, wherein processing the MAC signaling comprises: consuming a MAC-CE derived from the MAC signaling, or sending a message comprising the MAC-CE from a first MAC layer of the first DU to a second MAC layer of a second DU. For example, the DU-to-DU interface may connect the first MAC layer and the second MAC layer. For example, block 1010 may correspond to 712 and 713 of FIGS. 7, 812 and 813 of FIG. 8, or 912 and 913 of FIG. 9. The method 1000 reduces latency in the telecommunications system as a whole. This is because various tasks (as assigned by the network provider) such as forwarding of MAC signaling are able to bypass the O-CU, and may be performed directly between the O-DUs. The removal of the O-CU overhead increases the rate of transmission and speed of communications reducing overall latency.

Additionally, because CA is no longer limited by the capabilities of existing O-DUs, the presented solutions increase the ability of networks to utilize CA in broader contexts by more easily adding additional O-DUs when needed.

In some aspects, at least one of the message or the MAC signaling comprises a UE ID of the UE.

In some aspects, the UE ID comprises a C-RNTI of the UE.

In some aspects, block 1005 includes receiving the MAC signaling from the other DU over the DU-to-DU interface.

In some aspects, block 1005 includes receiving the MAC-CE from the UE, the MAC signaling comprising the MAC-CE.

In some aspects, block 1005 includes receiving the MAC-CE from the UE over at least one of an UL-SCH, a PUCCH, or a PUSCH.

In some aspects, block 1010 includes: determining a target DU based on the MAC signaling, wherein the target DU is the second DU; and generating the MAC-CE for the target DU, the MAC-CE including at least part of the MAC signaling.

In some aspects, block 1010 includes: parsing the MAC signaling at the first MAC layer; and determining an association of the MAC-CE with the second DU based on the MAC signaling, wherein sending the message to the second MAC layer of the second DU comprises sending the message in accordance with the association.

In some aspects, determining the association of the MAC-CE with the second DU comprises determining the association of the MAC-CE with the second DU based on a CC-to-DU mapping.

In some aspects, determining the association of the MAC-CE with the second DU comprises generating a new MAC CE based on the CC-to-DU mapping.

In some aspects, method 1000 further includes sending the message to the second DU, wherein the MAC signaling is received from the UE.

In some aspects, one of the other DU, the first DU, or the second DU is a primary DU configured to centrally process and distribute MAC CEs.

In some aspects, the MAC signaling is received from the other DU.

In some aspects, the primary DU has an established control signal connection to the UE.

In some aspects, the primary DU is configured to provide a primary cell of the UE.

In some aspects, the MAC signaling received from the other DU is received via a DU-to-DU interface and comprises the MAC-CE.

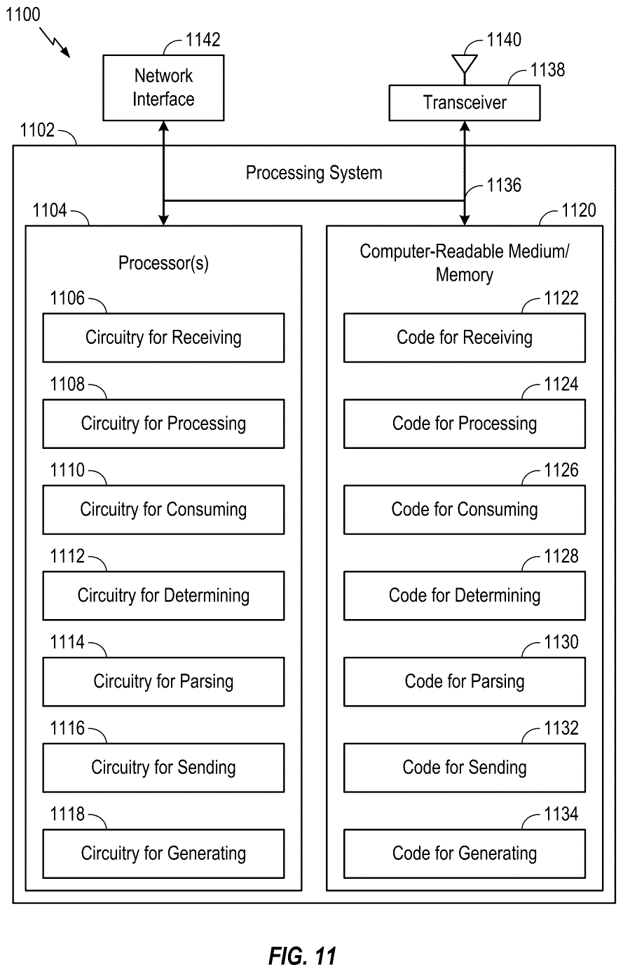

In some aspects, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative operations are possible consistent with this disclosure.

### Example Communications Device

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1102 coupled to a transceiver 1138 (e.g., a transmitter and/or a receiver) and/or a network interface 1142. The transceiver 1138 is configured to transmit and receive signals for the communications device 1100 via an antenna 1140, such as the various signals as described herein. The network interface 1142 is configured to obtain and send signals for the communications device 1100 via communications link(s), such as a backhaul link, midhaul link, and/or fronthaul link as described herein, such as with respect to FIG. 2. The processing system 1102 may be configured to perform processing functions for the communications device 1100, including processing signals received and/or to be transmitted by the communications device 1100.

The processing system 1102 includes one or more processors 1104 and a computer-readable medium/memory 1120. In various aspects, one or more processors 1104 may be representative of the one or more processors 308, as described with respect to FIG. 3. The one or more processors 1104 are coupled to the computer-readable medium/memory 1120 via a bus 1136. In certain aspects, the computer-readable medium/memory 1120 is configured to store instructions (e.g., computer-executable code), including code 1122-1134, that when executed by the one or more processors 1104, cause the one or more processors 1104 to perform the method 1000 described with respect to FIG. 10, or any aspect related to it, including any operations described in relation to FIG. 10. The computer-readable medium/memory 1120 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1120 stores code (e.g., executable instructions), including code for receiving 1122, code for processing 1124, code for consuming 1126, code for determining 1128, code for parsing 1130, code for sending 1132, and code for generating 1134. Processing of the code 1122-1134 may enable and cause the communications device 1100 to perform the method 1000 described with respect to FIG. 10, or any aspect related to it.

The one or more processors 1104 include circuitry configured to implement (e.g., execute) the code stored in the computer-readable medium/memory 1120, including circuitry for receiving 1106, circuitry for processing 1108, circuitry for consuming 1110, circuitry for determining 1112, circuitry for parsing 1114, circuitry for sending 1116, and circuitry for generating 1118. Processing with circuitry 1106-1118 may enable and cause the communications device 1100 to perform the method 1000 described with respect to FIG. 10, or any aspect related to it.

Various components of the communications device 1100 may provide means for performing the method 1000 described with respect to FIG. 10, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1138, antenna 1140, and/or network interface 1142 of the communications device 1100 in FIG. 11, and/or one or more processors 1104 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1138, antenna 1140, and/or network interface 1142 of the communications device 1100 in FIG. 11, and/or one or more processors 1104 of the communications device 1100 in FIG. 11. For example, means for the method 1000 described with respect to FIG. 10, or any aspect related to it, may include means for determining and means for generating.

### Example Clauses

Implementation examples are described in the following numbered clauses:
Clause 1: A method for wireless communications at a first DU comprising: receiving MAC signaling associated with a UE from the UE or another DU; and processing the MAC signaling, wherein processing the MAC signaling comprises: consuming a MAC-CE derived from the MAC signaling, or sending a message comprising the MAC-CE from a first MAC layer of the first DU to a second MAC layer of a second DU, over a DU-to-DU interface.
Clause 2: The method of Clause 1, wherein at least one of the message or the MAC signaling comprises a UE ID of the UE.
Clause 3: The method of Clause 2, wherein the UE ID comprises a C-RNTI of the UE.
Clause 4: The method of Clause 3, wherein receiving the MAC signaling comprises receiving the MAC signaling from the other DU over the DU-to-DU interface.
Clause 5: The method of any one of Clauses 1-4, wherein receiving the MAC signaling comprises receiving the MAC-CE from the UE, the MAC signaling comprising the MAC-CE.
Clause 6: The method of Clause 5, wherein receiving the MAC signaling comprises receiving the MAC-CE from the UE over at least one of an UL-SCH, a PUCCH, or a PUSCH.
Clause 7: The method of any one of Clauses 1-6, wherein processing the MAC signaling comprises: determining a target DU based on the MAC signaling, wherein the target DU is the second DU; and generating the MAC-CE for the target DU, the MAC-CE including at least part of the MAC signaling.
Clause 8: The method of any one of Clauses 1-7, wherein processing the MAC signaling comprises: parsing the MAC signaling at the first MAC layer; and determining an association of the MAC-CE with the second DU based on the MAC signaling, wherein sending the message to the second MAC layer of the second DU comprises sending the message in accordance with the association.
Clause 9: The method of Clause 8, wherein determining the association of the MAC-CE with the second DU comprises determining the association of the MAC-CE with the second DU based on a CC-to-DU mapping.
Clause 10: The method of Clause 8, wherein determining the association of the MAC-CE with the second DU comprises generating a new MAC CE based on the CC-to-DU mapping.
Clause 11: The method of any one of Clauses 1-10, further comprising: sending the message to the second DU, wherein the MAC signaling is received from the UE.
Clause 12: The method of any one of Clauses 1-11, wherein one of the other DU, the first DU, or the second DU is a primary DU configured to centrally process and distribute MAC CEs.
Clause 13: The method of Clause 12, wherein the MAC signaling is received from the other DU.
Clause 14: The method of Clause 12, wherein the primary DU has an established control signal connection to the UE.
Clause 15: The method of Clause 12, wherein the primary DU is configured to provide a primary cell of the UE.
Clause 16: The method of any one of Clauses 1-15, wherein the MAC signaling received from the other DU is received via a DU-to-DU interface and comprises the MAC-CE.
Clause 17: One or more apparatuses, comprising: one or more memories comprising executable instructions; and one or more processors configured to execute the executable instructions and cause the one or more apparatuses to perform a method in accordance with any one of Clauses 1-16.
Clause 18: One or more apparatuses configured for wireless communications, comprising: one or more memories; and one or more processors, coupled to the one or more memories, configured to cause the one or more apparatuses to perform a method in accordance with any one of Clauses 1-16.
Clause 19: One or more apparatuses configured for wireless communications, comprising: one or more memories; and one or more processors, coupled to the one or more memories, configured to perform a method in accordance with any one of Clauses 1-16.
Clause 20: One or more apparatuses, comprising means for performing a method in accordance with any one of Clauses 1-16.
Clause 21: One or more non-transitory computer-readable media comprising executable instructions that, when executed by one or more processors of one or more apparatuses, cause the one or more apparatuses to perform a method in accordance with any one of Clauses 1-16.
Clause 22: One or more computer program products embodied on one or more computer-readable storage media comprising code for performing a method in accordance with any one of Clauses 1-16.
Clause 23: One or more apparatuses configured for wireless communications, comprising: a processing system that includes one or more processors and one or more memories coupled with the one or more processors, the processing system configured to cause the one or more apparatuses to perform a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communication at a first distributed unit (DU), comprising a processing system that includes one or more processors and one or more memories coupled with the one or more processors, the processing system configured to cause the first DU to:
receive medium access control (MAC) signaling associated with a user equipment (UE) from the UE or another DU; and
process the MAC signaling, wherein to cause the first DU to process the MAC signaling, the processing system is configured to cause the first DU to:
consume a MAC control element (MAC-CE) derived from the MAC signaling, or
send a message comprising the MAC-CE from a first medium access control (MAC) layer of the first DU to a second MAC layer of a second DU, over a DU-to-DU interface.

2. The apparatus of claim 1, wherein at least one of the message or the MAC signaling comprises a UE identifier (UE ID) of the UE.

3. The apparatus of claim 2, wherein the UE ID comprises a Cell Radio Network Temporary Identifier (C-RNTI) of the UE.

4. The apparatus of claim 3, wherein to cause the first DU to receive the MAC signaling, the processing system is further configured to cause the first DU to receive the MAC signaling from the other DU over the DU-to-DU interface.

5. The apparatus of claim 1, wherein to cause the first DU to receive the MAC signaling, the processing system is further configured to cause the first DU to receive the MAC-CE from the UE, the MAC signaling comprising the MAC-CE.

6. The apparatus of claim 5, wherein to receive the MAC signaling, the processing system is configured to cause the first DU to receive the MAC-CE from the UE over an uplink shared channel (UL-SCH).

7. The apparatus of claim 1, wherein to process the MAC signaling, the processing system is further configured to cause the first DU to:
determine a target DU based on the MAC signaling, wherein the target DU is the second DU; and
generate the MAC-CE for the target DU, the MAC-CE including at least part of the MAC signaling.

8. The apparatus of claim 1, wherein to process the MAC signaling, the processing system is further configured to cause the first DU to:
parse the MAC signaling at the first MAC layer; and
determine an association of the MAC-CE with the second DU based on the MAC signaling, wherein to cause the first DU to send the message to the second MAC layer of the second DU, the processing system is configured to cause the first DU to send the message in accordance with the association.

9. The apparatus of claim 8, wherein to determine the association of the MAC-CE with the second DU, the processing system is further configured to cause the first DU to determine the association of the MAC-CE with the second DU based on a component carrier-to-DU mapping (CC-to-DU mapping).

10. The apparatus of claim 8, wherein to determine the association of the MAC-CE with the second DU, the processing system is further configured to cause the first DU to generate a new MAC CE based on a component carrier-to-DU mapping (CC-to-DU mapping).

11. The apparatus of claim 1, wherein the processing system is further configured to cause the first DU to send the message to the second DU, wherein the MAC signaling is received from the UE.

12. The apparatus of claim 1, wherein one of the other DU, the first DU, or the second DU is a primary DU configured to centrally process and distribute MAC CEs.

13. The apparatus of claim 12, wherein the MAC signaling is received from the other DU.

14. The apparatus of claim 12, wherein the primary DU has an established control signal connection to the UE.

15. The apparatus of claim 12, wherein the primary DU is configured to provide a primary cell of the UE.

16. The apparatus of claim 1, wherein the MAC signaling received from the other DU is received via the DU-to-DU interface and comprises the MAC-CE, and wherein the DU-to-DU interface connects the first MAC layer to the second MAC layer.

17. A method for standardized communications for a first distributed unit (DU) comprising:
receiving medium access control (MAC) signaling associated with a user equipment (UE) from the UE or another DU; and
processing the MAC signaling, wherein the processing comprises:
consuming a MAC control element (MAC-CE) derived from the MAC signaling, or
sending a message comprising the MAC-CE from a first medium access control (MAC) layer of the first DU to a second MAC layer of a second DU, over a DU-to-DU interface.

18. The method of claim 17, wherein the MAC signaling obtained from the other DU is received via the DU-to-DU interface and comprises the MAC-CE.

19. The method of claim 17, wherein the processing the MAC signaling further comprises at least one of:
a first processing comprising:
determining a target DU based on the MAC signaling, wherein the target DU is the second DU; and
generating the MAC-CE for the target DU, the MAC-CE including at least part of the MAC signaling,
or a second processing comprising:
parsing the MAC signaling at the first MAC layer; and
determining an association of the MAC-CE with the second DU based on the MAC signaling, wherein the sending of the message is in accordance with the association.

20. A communications interface for a first distributed unit (DU) comprising:
means for receiving medium access control (MAC) signaling from a UE or another DU; and
means for processing the MAC signaling, wherein the means for processing comprises:
means for consuming a MAC control element (MAC-CE) derived from the MAC signaling, or
means for sending a message comprising the MAC-CE from a first medium access control (MAC) layer of the first DU to a second MAC layer of a second DU, over a DU-to-DU interface.
